(19) United States
(12) Patent Application Publication
(10) Pub. No.: US 2025/0066029 A1
(43) Pub. Date: Feb. 27, 2025

(54) EXTERNAL POWER CONTROL MODULE FOR AND METHOD TO OPEN COWLING OF AN AIRCRAFT ENGINE NACELLE

(71) Applicant: AIRBUS OPERATIONS (S.A.S.), Toulouse (FR)

(72) Inventor: Pablo REVERT, Toulouse Cedex (FR)

(21) Appl. No.: 18/455,334

(22) Filed: Aug. 24, 2023

(51) Int. Cl. B64D 29/06; F02K 1/78

(52) U.S. Cl. CPC B64D 29/06; F02K 1/78

(57) ABSTRACT

A system for opening a cowling on a nacelle of an engine of an aircraft, the system including: an actuator configured to move the cowling between a closed position and an open position; a distributor on the nacelle including a first electrical connector; cabling extending from the distributor to an actuator, wherein the cabling is attached to the nacelle and/or the engine; a power source external to the aircraft, and a cable attached to the power source and having a distal end with a second electrical connector configured to attach to the first electrical connector of the distributor, wherein electrical power from the power source flows through the cable, the distributor and the cabling to power the actuator.

### TECHNICAL FIELD

The invention is in the field of maintenance of jet aircraft engines, and particularly to cowlings of a nacelle for an engine.

### BACKGROUND

Aircraft engines, such as jet engines, turbofan and gas turbine driving a shrouded propeller, are commonly housed in a nacelle having an aerodynamic outer surface. The nacelle includes cowlings that open to allow mechanics to service the engine within the nacelle. The lower edges of the cowlings typically swing open to expose the engine. The upper edges of the cowling are hinged to a pylon supporting the engine. Actuators, e.g. extendible rods (linear actuators), open and close the cowlings.

The actuators to open the cowlings are conventionally powered by the aircraft. The actuators may be electrically powered from an electrical power source within the aircraft. Alternatively, the actuators may be hydraulically powered by a source of pressurized hydraulic liquid within the aircraft. Another conventional approach to opening cowlings is for a mechanic outside of the aircraft to connect a hydraulic pump to a hydraulic port on each of the hydraulic actuators that open the cowling.

### SUMMARY OF INVENTION

The inventors recognized a need for a better approach to open cowlings that does not require power provided by the aircraft to open the cowlings. The invention may be embodied as a system for opening aircraft nacelle cowlings using an external power source. A maintenance operator may open the cowlings without having to access a power source in the aircraft to perform maintenance inside the nacelle. The system may include electric actuators connected to a battery external to the aircraft by means of a socket mounted to a lower portion of the nacelle. The opening and closing of the cowling by the actuators are controlled by a control panel that may be a hand-held device or attached to a controller on the battery.

The invention may be embodied as a system for opening a cowling on a nacelle of an engine of an aircraft, the system including: an actuator configured to move the cowling between a closed position and an open position; a distributor on the nacelle including a first electrical connector; cabling extending from the distributor to an actuator, wherein the cabling is attached to the nacelle and/or the engine; a power source external to the aircraft, and a cable attached to the power source and having a distal end with a second electrical connector configured to attach to the first electrical connector of the distributor, wherein electrical power from the power source flows through the cable, the distributor and the cabling to power the actuator.

The distributor may be flush with or recessed in an outer skin of the nacelle. The distributor may be mounted to a lower half of the nacelle, such as a front region of the nacelle which is forward of the cowling.

The cabling may extend between inner and outer skins of the front region of the nacelle. The cabling may be held by wiring harness mounted to the engine or a pylon supporting the engine.

A controller external to the aircraft may be configured to operate the actuator by applying electrical power to the actuator from the power source. The controller and external power supply may be in a cart moveable along the ground to a position near the nacelle.

The actuator may be is isolated from any source of power on the aircraft.

The invention may be embodied as a system for opening cowlings on a nacelle of an engine of an aircraft, the system including: a front region of the nacelle; forward cowlings of the nacelle arranged in a pair aft of the front region and on port and starboard sides of the nacelle, wherein each of the forward cowlings is pivotably mounted to the engine or a pylon supporting the engine; actuators extending between the forward cowlings and the pylon or engine, wherein the actuators are configured to move the forward cowlings from a closed position to an open position, and each of the forward cowlings is moved by at least one of the actuators; a distributor on the front region of the nacelle, wherein the distributor includes a first electrical connector configured to connect to a power source external to the aircraft, and cabling extending from the distributor to the actuators, wherein the cabling is attached to the nacelle and/or the engine; wherein electrical power from the power source flows through the cable, the distributor and the cabling to power the actuators.

The system may include aft cowlings of the nacelle arranged in a pair aft of the forward cowlings and on the port and the starboard sides of the nacelle, wherein each of the aft cowlings is pivotably mounted to the engine or the pylon supporting the engine; and second actuators extending between the aft cowlings and the pylon or engine, wherein the second actuators are configured to move the aft cowlings from a closed position to an open position, and each of the aft cowlings is moved by at least one of the second actuators, wherein the cabling extends to the second actuators and the electrical power from the power source flows through the cable, the distributor and the cabling to power the second actuators.

The distributor may be flush with or recessed with respect to an outer surface of the nacelle. The distributor may be mounted to a lower half of the nacelle.

The cabling may extend between inner and outer skins of the front region of the nacelle. The cabling may be supported in a wiring harness mounted to the engine or a pylon supporting the engine, and the wiring harness holds the cabling.

The system may include a controller external to the aircraft, wherein the controller is configured to operate the actuator by applying electrical power to the actuator from the power source. The controller and power supply may be in a cart moveable along the ground to a position near the nacelle.

The invention may be embodied as a method to open a cowling of a nacelle of an aircraft, the method comprising: moving a power source external to the aircraft along the ground and to a position proximate the nacelle; connecting a cable attached to the external power source to a distributor on the nacelle, wherein the distributor is conductively coupled to cabling mounted to the nacelle and/or an engine within the nacelle; operating a controller to control the power source to apply power via the cable, the cable, the distributor, and the cabling to an actuator electrically connected to the cabling, and opening the cowling on the nacelle by the application of the electrical power to the actuator.

The method may further include closing the cowling; turning a motor attached to the actuator as the actuator is retracted by the closing of the cowling; and transmitting electrical energy generated by the turning of the motor through the cabling, the distributor, the cable and into the power source.

The method may further include latching the cable to the distributor while the cowling is open, confirming that the cowling is properly closed, and after the confirmation, releasing the cable from the distributor.

### SUMMARY OF DRAWINGS

Embodiments of the invention are illustrated in the drawings which are:

FIG. 1 is a schematic illustration showing the side of an aircraft with a wing mounted engine housed in a nacelle.

FIG. 2 illustrates a jet engine with a fan housed in a nacelle.

FIG. 3 is a front view of a nacelle and jet engine with cowlings opened.

### DETAILED DESCRIPTION

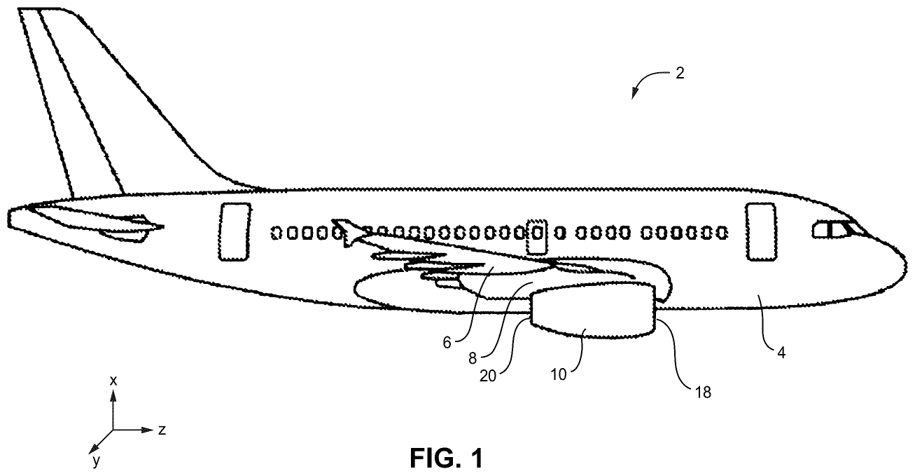

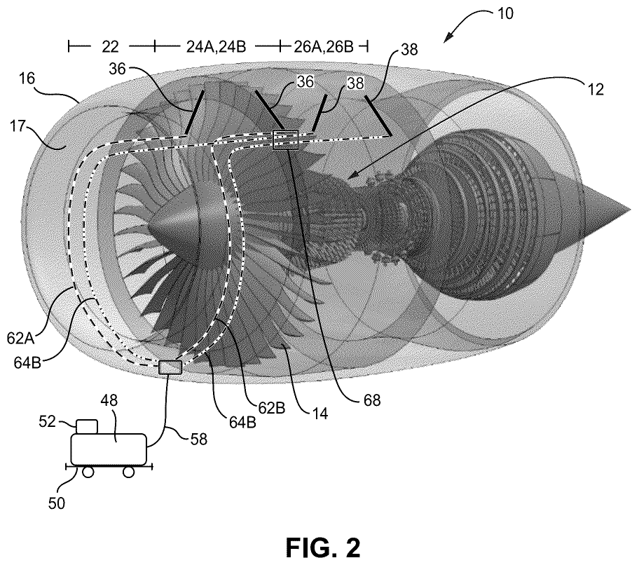

FIG. 1 shows an aircraft 2 which includes a fuselage 4 on either side of which are wings 6. A mounting pylon 8 extends below each wing 6. The mounting pylon 8 supports a nacelle 10 and an engine 12 surrounded by the nacelle. Engine 12 may be a gas turbine (jet) engine, an electrically driven motor, piston driven engine or other system that generates thrust to propel the aircraft in flight. The engine may drive a fan 14 (FIG. 2) at the front of the engine.

As shown in FIG. 1, the fuselage has a longitudinal Z axis with a positive orientation in a direction from the tail to the cockpit of the fuselage. The axis Z is parallel to the longitudinal axis of the nacelle 10 and engine 12. The Y axis is horizontal and the X axis while the aircraft is on the ground. The X, Y and Z axes are mutually orthogonal and form an orthonormal reference system. The pylon 8 is parallel to the longitudinal axis Z and may have a height in the direction of the X axis. The cross sections of the nacelle and engine may be in a plane of the X and Y axes.

FIG. 2 shows the nacelle 10 housing engine 12 and fan 14. The nacelle may have a smooth outer skin 16 exposed to ambient air. The outer skin is smooth to minimize aerodynamic drag. Joints between sections of the nacelle may be flush with the skin. Also, latches and other components near the skin may be flush with the skin 16 to reduce aerodynamic drag.

The nacelle 10 is hollow and surrounds engine 12 to form a housing for the engine. The outer skin 16 extends between an open inlet 18 and an open outlet 20 to allow airflow to flow into the engine and exhaust from the engine and fan. The nacelle may be substantially circular in a cross section along the Z axis. The nacelle may be substantially cylindrical, or the diameter of the nacelle may vary along its length (Z-axis) to accommodate the engine and fan.

The upper region of the nacelle 10 connects to pylon 8. The pylon supports the engine and the nacelle. The nacelle need not provide structural support for the engine. The pylon provides passages (conduits) for hydraulic and fuel lines, electrical power cables and data cables for control signals sent to the engine and sensor signals monitoring the engine. Pylons are often narrow and substantially filled with mounts for the engine and nacelle. The passages in pylons available for passages may be substantially filled with cables connected to the engine. Also, pylons tend to be hot due to the proximity of hot gases generated in the engine. Because of the heat, cables in the pylon are covered by insulation sleeves to prevent heat damage to the cables.

The skin of the nacelle may be a composite fiber material or a metallic sheet material. Stringers on the inside surface of the skin provide structural support for the skin. The front region 22 of the nacelle may include an inner skin 17 to provide an aerodynamically smooth surface for airflow entering the engine and passing through the fan. In the front region, the stringers may be ribs spanning between the outer and inner skin. The front region 22 includes an annular leading edge at the inlet 18 to the nacelle. The skin of the front region includes the outer skin 16 and an inner skin 17, wherein both skins extend aft from the leading edge.

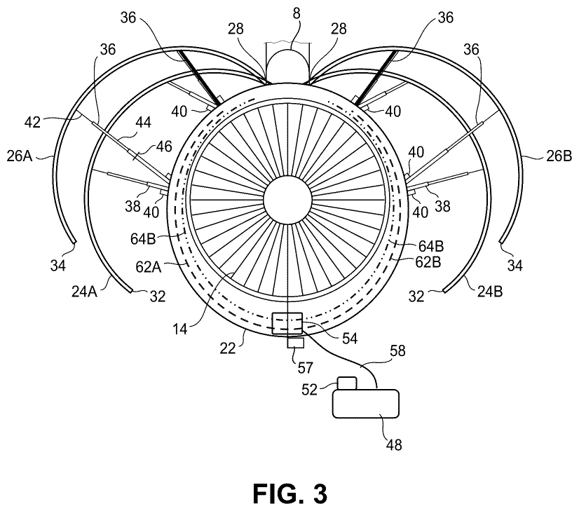

As shown in FIGS. 2 and 3, the nacelle includes cowlings such as forward cowling sections 24A, 24B, and aft cowling sections 26A, 26B. Each of the cowling sections may be semi-circular in cross section and have a length along the Z axis. Each pair of cowling sections 24A, 24B and 26A, 26B are on opposite sides of the nacelle and are arranged to open in a clam shell manner to provide access to, for example, the engine, fan and thrust reverser.

The forward cowling sections 22A, 22B are aft of and may be adjacent the front region 22 of the nacelle. The forward cowling sections may house the fan and the compressor portion of the engine and may cover the combustor of the engine. The aft cowling 26A, 26B is aft of and may be adjacent the forward cowling. The aft cowling 26A, 26B may house a thrust reverser and a turbine section of the engine.

Opening the cowling sections 24A, 24B, 26A, 26B allows a mechanic to access and service the engine. The cowling sections are configured to be opened only while the aircraft is stationary and on the ground.

The cowling sections 24A, 24B, 26A, 26B may form portions of the outer skin of the nacelle. The cowlings may open by pivoting about mounts 28, 30 attached to and within the pylon. Each of the forward cowling sections 22A, 22B have an upper edge connected to mount 28, such as a hinge, that couples the cowling sections to the pylon. Mount 28 allows the cowling sections to pivot between open and closed positions. The forward cowling sections 24A, 24B have lower edges 32 substantially parallel to the Z axis. The lower edges may abut when the forward cowling sections are closed. Similar to the forward cowling sections, the aft cowling sections 26A, 26B have upper edges attached to mounts 30 connected to the pylon. The lower edges 34 of the aft cowling sections may abut when the aft cowling sections are closed.

Actuators within the nacelle move the cowling sections between open and closed positions. The actuators are driven by an electrical motor 40. The actuators may be powered hinges that rotate to open the cowling sections or linear actuators that telescope to open the sections. FIGS. 2 and 3 show linear actuators 36, 38 within the nacelle that move the cowling sections between open and closed positions. Linear actuators 36 are attached to the forwarding cowling sections, and linear actuators 38 are attached to the aft cowling sections.

The linear actuators include telescoping threaded rods each connected at one end to an inner surface of a cowling section and an opposite end connected to the engine or a support for the engine. Each cowling section may have two or more linear actuators spaced along the length (Z-axis) of the section. The linear actuators may be driven by a direct current (D.C.) motor 40 at the end of the actuator attached to the engine. Each linear actuator 36, 38 may have a threaded rod 42 turned by the motor and extends from a sleeve 44 of the actuator. Also, each linear actuator 36, 38 may have a pin 46 or other mechanical lock that is inserted into the rod and sleeve while the cowling section is open and to prevent the rod from turning when not driven by the motor.

Power is supplied to the motors 40 of the linear actuators 36, 38 from an external power source 48, such as a battery or generator. The external power source may be mounted on a cart 50 that is moved along the ground by maintenance personnel from a storage position in an airport to a position on the tarmac apron near the nacelle of the aircraft.

A controller 52 for the power source 48 may also be in the cart. Controller 52 includes a user interface, such as a keypad and a display. The user interface allows maintenance personnel to confirm that the external power source is connected to the linear actuators to supply electrical power and activate the actuators to open and close the cowling sections. The cart may store the pins 46 used for locking the linear actuators to hold the cowling sections in open positions.

A distributor 54 is mounted to the nacelle and includes an electrical connector 56, e.g., socket, configured to establish a connection for electrical power and data with the controller 52 and external power source 48 in the cart 50. The distributor distributes the electrical power received from the external power source to cabling within the nacelle that delivers electrical power to actuators 36, 38 which open the cowling sections. An outer surface of the distributor may be flush with the outer skin of the nacelle or be recessed with respect to the outer skin. The distributor may be covered by a door which is flush with the outer skin. The door is closed while the aircraft is in flight and is opened to connect the distributor to the controller and external power source.

The electrical connector 56, e.g., a female socket, of the distributor 54 may include a female electrical connector configured to receive a second electrical connector 57, e.g., male connector, attached to an end of a cable 58 extending from the electrical power source 48 and controller 52 in the cart. Cable 58 may include only two wires, e.g., positive and negative polarities, which are connected to positive and negative terminals of the external power source 48, e.g., a battery. Cable 58 may include additional wires for data communications between the controller 52 and the linear actuators 36, 38. The distributor 54 may include a data port 60 for data communications. The male electrical connector 56 on the cable 58 includes electrical connections, e.g., prongs, for the wires carrying electrical power between the electrical power source and to the distributor, and optionally a data connector for data flowing between the controller 52 and the linear actuators. The data port 60 is not needed if data is transmitted via the two wires used to transmit electrical power.

Cable 58 may have an outer surface coated by a fluorescent color, fitted with reflectors and/or with LED lights to improve the visibility of the cable. A visible cable attached to the nacelle provides an additional indication to pilots in the cockpit of the aircraft that cowlings may be open.

The electrical connector 56 in the distributor and/or the second electrical connector 57 on the cable may be configured such that they latch together when one is inserted in the other. The latch may not release until the cowlings are properly closed and not until cowling latches are properly secured. The actuators 36, 38 may include sensors which detected when the actuators are retracted and thus indicating that the cowling is closed. The sensors may send data to the controller 52 such as through the cabling, distributor and cable. Similarly, the latches on the cowlings may be monitored by sensors that detect when the latches are closed to secure the cowlings in a closed position. The sensor may transmit data via wires extending to one or more of the actuators. The data is sent by the actuator to the controller. The controller may confirm that data is received from sensors for all latches securing the cowlings before sending a command via cable 58 to one or both electrical connectors 56, 57, and/or the distributor to allow the electrical connector 57 and cable 58 to disengage from the distributor.

Distributor 54 may be mounted to the front region 22 of the nacelle which is forward of the cowling sections. The distributor may be at or near the lowest region of the front region. Or, the distributor may be at the lowest third or lowest half of the front region. Positioning the distributor 54 at the front region 22 keeps the distributor and much of the cabling associated with the distributor away from the hot regions of the engine. The amount of insulation needed for the cabling is reduced because much of the cabling is away from the hot portion of the engine.

Cabling 62A, 62B, 64A, 64A, provide electrical power and data communications between the distributor 54 and the linear actuators 36, 38. Cables 62A, 62B provide conductive connections from the distributor to the linear actuators 36 for the forward cowlings 24A, 24B. Cables 64A, 64B provide conductive connections between the distributor and the linear actuators 38 for the aft cowlings 26A, 26B. Cables 62A, 64A are generally on the starboard side of the nacelle and engine, and cables 62B, 64B are on the port side of the nacelle and engine. Cabling 62A, 62B, 64A, 64A may be arranged in the front region 22 of the nacelle such as by being attached to ribs between outer and inner skins of the nacelle. The cabling extends from an aft end of the front region and into wiring harnesses 68 attached to the engine or pylon. The wiring harnesses 68 carry the cabling to the linear actuators.

To open the cowlings 24A, 24B, 26A, 26B, a mechanic moves the cart 50 along the ground to a position near the nacelle 10 of the aircraft 2. The mechanic pulls cable 58 from the cart and inserts an electrical connector 56 at the end of the cable into an electrical connector 56, e.g., a socket, in the distributor 54. The mechanic operates the controller 52 to confirm that there is a proper electrical connection between the power source 48 and the actuators 36, 38, and then selects at least one of the forward and aft cowlings to open.

Using the controller 52, the mechanic causes electrical energy from the external power source 48 to be applied to one or more of the actuators 36, 38 to open the forward and/or aft cowlings. For example, the mechanic may open the forward cowlings before the aft cowlings or may open the cowlings on only one side of the nacelle. Once the cowlings are opened, the mechanic may install pin(s) 46 to prevent closure of the cowlings if the actuator(s) become disconnected from the external power source.

Controller 52 may include a processor and electronic circuits which receive data from the distributor whether: the electrical connectors 56, 57 are latched together, an electrical connection is established to each of the actuators, and the cowlings are in open or closed positions. The controller may process the data and inputs from the mechanic operating the controller to issue commands to the linear actuators and distributor.

The actuators 36, 38 may be isolated from power sources within the aircraft. Isolating the actuators may provide technical benefits such as reducing the cabling in the aircraft between an internal power source and the actuators and reducing the cabling passing through the pylons. Often there is little available space within a pylon for additional cabling and any cabling in the pylon requires insulation due to the heat applied by the engine to the pylon. Reducing the amount of cabling and insulation for cabling can provide weight savings for the aircraft and reduce the components in the aircraft.

The system may recover energy as the open cowlings close. The cowlings may be driven by their own weight as they are lowered to a closed position. This movement may cause a nut on a screw jack of the actuator(s) to rotate as the screw moves through the nut. The rotational movement is transmitted through an epicyclic gear train to the motor 40 to cause a rotor in the motor to turn and generate eddy currents and Laplace forces, which in turn generate a resistive torque in relation to the direction of rotation of the rotor. The energy contained in the eddy currents can be applied to charge a battery in the power source 48 and as resistive torque to slow the closing of the cowlings.

Other advantages include avoiding equipment qualification costs for an internal power supply for the actuators that open the cowlings or cabling between an existing internal power supply and the cowlings. The cost to qualify equipment to fly onboard an aircraft is substantially greater than the cost for external equipment used to service an aircraft on the ground.

While at least one exemplary embodiment of the present invention(s) is disclosed herein, it should be understood that modifications, substitutions, and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless this application states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for opening a cowling on a nacelle of an engine of an aircraft, the system comprising:
an actuator configured to move the cowling between a closed position and an open position;
a distributor on the nacelle including a first electrical connector;
cabling extending from the distributor to an actuator, wherein the cabling is attached to the nacelle and/or the engine;
a power source external to the aircraft, and
a cable attached to the power source and having a distal end with a second electrical connector configured to attach to the first electrical connector of the distributor,
wherein electrical power from the power source flows through the cable, the distributor and the cabling to power the actuator.

2. The system of claim 1, wherein the distributor is flush with or recessed in an outer skin of the nacelle.

3. The system of claim 1, wherein the distributor is mounted to a lower half of the nacelle.

4. The system of claim 1, wherein the distributor is mounted to a front region of the nacelle which is forward of the cowling.

5. The system of claim 4, wherein the cabling extends between inner and outer skins of the front region of the nacelle.

6. The system of claim 1, further comprising a wiring harness mounted to the engine or a pylon supporting the engine, and the wiring harness holds the cabling.

7. The system of claim 1, further comprising a controller external to the aircraft, wherein the controller is configured to operate the actuator by applying electrical power to the actuator from the power source.

8. The system of claim 7, further comprising a cart, wherein the power supply and the controller are in the cart and the cart is moveable along the ground to a position near the nacelle.

9. The system of claim 1, wherein the actuator is isolated from any source of power on the aircraft.

10. A system for opening cowlings on a nacelle of an engine of an aircraft, the system comprising:
a front region of the nacelle;
forward cowlings of the nacelle arranged in a pair aft of the front region and on port and starboard sides of the nacelle, wherein each of the forward cowlings is pivotably mounted to the engine or a pylon supporting the engine;
actuators extending between the forward cowlings and the pylon or engine, wherein the actuators are configured to move the forward cowlings between a closed position and an open position, and each of the forward cowlings is moved by at least one of the actuators;
a distributor on the front region of the nacelle, wherein the distributor includes a first electrical connector configured to connect to a power source external to the aircraft, and
cabling extending from the distributor to the actuators, wherein the cabling is releasably attached to the nacelle and/or the engine;
wherein electrical power from the power source flows through the cable, the distributor and the cabling to power the actuators.

11. The system of claim 11, further comprising:
aft cowlings of the nacelle arranged in a pair aft of the forward cowlings and on the port and the starboard sides of the nacelle, wherein each of the aft cowlings is pivotably mounted to the engine or the pylon supporting the engine; and
second actuators extending between the aft cowlings and the pylon or engine, wherein the second actuators are configured to move the aft cowlings between a closed position and an open position, and each of the aft cowlings is moved by at least one of the second actuators,
wherein the cabling extends to the second actuators and the electrical power from the power source flows through the cable, the distributor and the cabling to power the second actuators.

12. The system of claim 11, wherein an outer surface of the distributor is flush with or recessed with respect to an outer surface of the nacelle.

13. The system of claim 11, wherein the distributor mounted to a lower half of the nacelle.

14. The system of claim 11, wherein the cabling extends between inner and outer skins of the front region of the nacelle.

15. The system of claim 11, further comprising a wiring harness mounted to the engine or a pylon supporting the engine, and the wiring harness holds the cabling.

16. The system of claim 11, further comprising a controller external to the aircraft, wherein the controller is configured to operate the actuator by applying electrical power to the actuator from the power source.

17. The system of claim 16, further comprising a cart, wherein the power supply and the controller are in the cart and the cart is moveable along the ground to a position near the nacelle.

18. A method to open a cowling of a nacelle of an aircraft, the method comprising:
moving a power source external to the aircraft along the ground and to a position proximate the nacelle;
connecting a cable attached to the external power source to a distributor on the nacelle, wherein the distributor is conductively coupled to cabling mounted to the nacelle and/or an engine within the nacelle;
operating a controller to control the power source to apply power via the cable, the cable, the distributor, and the cabling to an actuator electrically connected to the cabling, and
opening the cowling on the nacelle by the application of the electrical power to the actuator.

19. The method of claim 18, further comprising:
closing the cowling;
turning a motor attached to the actuator as the actuator is retracted by the closing of the cowling; and
transmitting electrical energy generated by the turning of the motor through the cabling, the distributor, the cable and into the power source.

20. The method of claim 18, further:
latching the cable to the distributor while the cowling is open,
confirming that the cowling is properly closed, and
after the confirmation, releasing the cable from the distributor.
